(19) United States
(12) Patent Application Publication
(10) Pub. No.: US 2007/0267044 A1
(43) Pub. Date: Nov. 22, 2007

(54) Blower system and method of using same

(75) Inventor: Robert G. Robinson, Hamilton, OH (US)

Correspondence Address: David E. Pritchard, Esq.;Kaivac, Inc., 401 S. Third St., Hamilton, OH, 45011, US

(73) Assignee: Kaivac, Inc.

(21) Appl. No.: 11/274,920

(22) Filed: Nov. 14, 2005

Related U.S. Application Data
(60) Provisional application No. 60/627,403, filed on Nov. 12, 2004.

(51) Int. Cl. B08B 5/04

(52) U.S. Cl. 134/21; 15/347

(57) ABSTRACT

A blower system for use with a cleaning machine includes a flexible elastic stretch-hose assembly. The assembly includes a length of flexible elastic stretch hose that has an elongation stretch ratio of at least about two to one. The length is fluidly connectable to the working-air outlet of a vacuum motor assembly or a blower motor assembly of a cleaning machine.

### CROSS REFERENCE TO RELATED APPLICATION

This patent document claims the benefit of the filing date of Provisional Application for Patent No. 60/627,403 entitled “Blower Tool and Method of Using Same” and filed on Nov. 12, 2004. The entire disclosure of Provisional Application for Patent No. 60/627,403 in incorporated into this patent document by reference.

### BRIEF DESCRIPTION OF THE DRAWINGS

FIG. 1 is perspective view of an operator holding a length of flexible elastic stretch hose of a cleaning machine, in accordance with the principles of the invention;

FIG. 2. is an enlarged view of a segment of the length of flexible elastic stretch hose of FIG. 1;

FIG. 2A is a cross-sectional view of the segment of FIG. 2, taken along line 2A-2A;

FIG. 3 is perspective view of the operator and cleaning machine of FIG. 1, with the length of flexible elastic stretch hose being in an elongated state;

FIG. 4. is an enlarged view of a segment of the length of flexible elastic stretch hose of FIG. 3;

FIG. 4A is a cross-sectional view of the segment of FIG. 4, taken along line 4A-4A; and

FIG. 5 is a partially cut-away perspective view of a cleaning machine, in accordance with the principles of the invention.

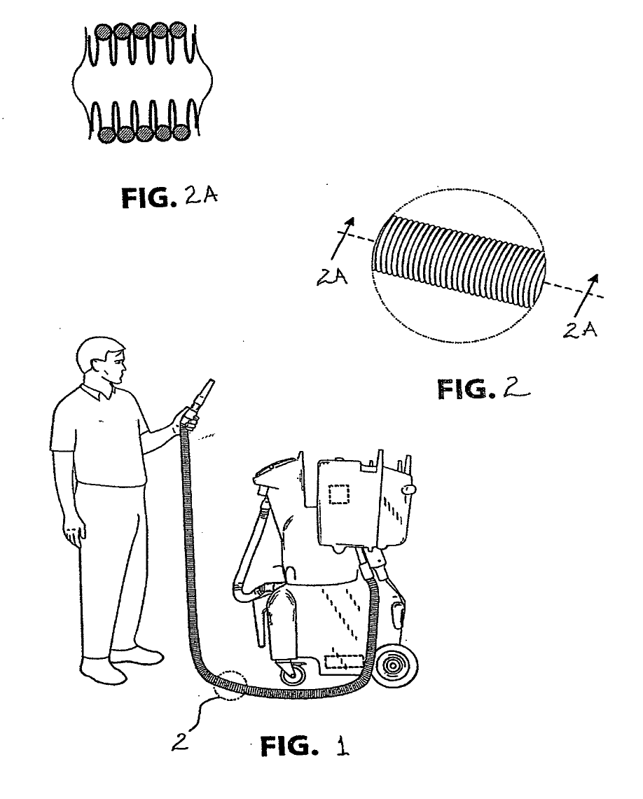

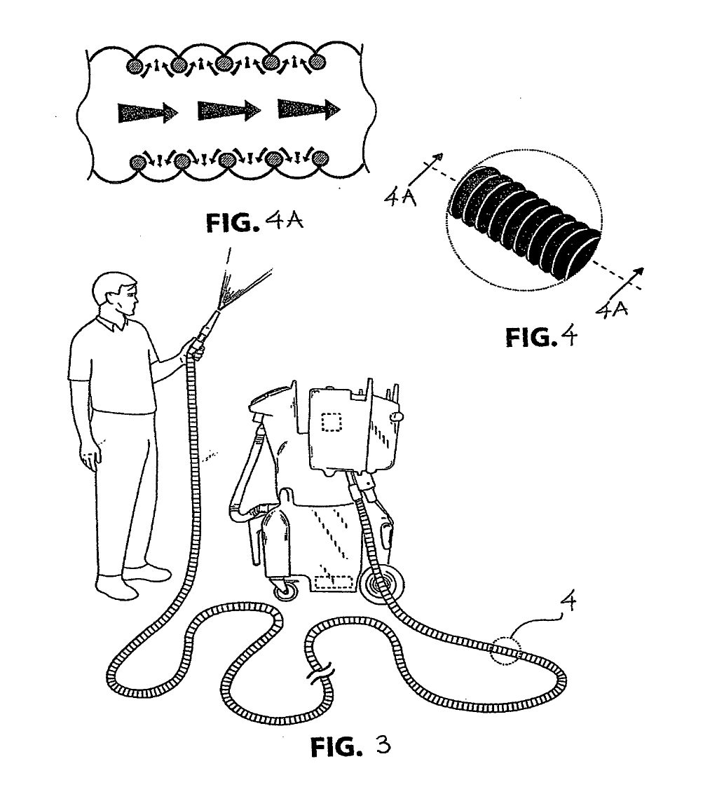

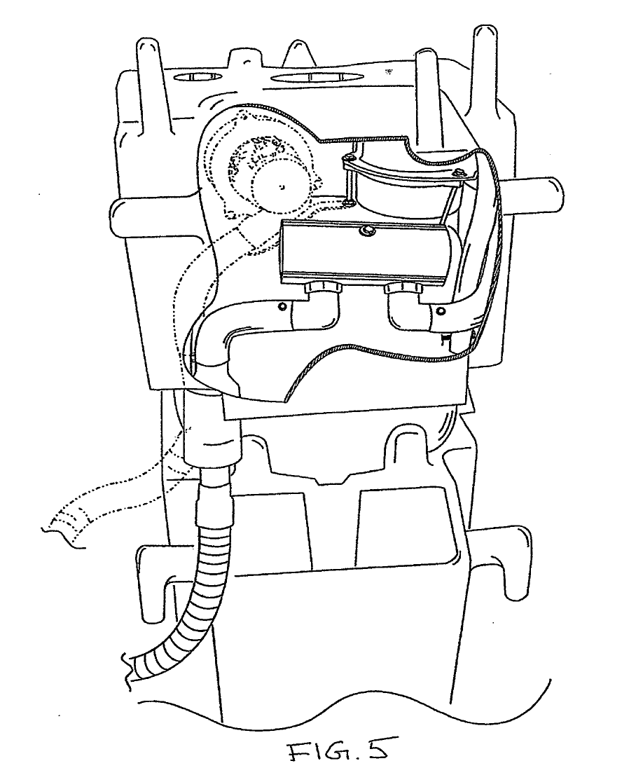

### DETAILED DESCRIPTION OF EMBODIMENTS OF THE INVENTION

This patent document incorporates the following patent documents in their entirety by reference: co-pending U.S. patent application Ser. No. 10/685,259 entitled “Ergonomic Multi-Functional Cleaning Machine” and filed on Oct. 14, 2003; U.S. Pat. No. 6,206,980 entitled “Multi-Functional Cleaning Machine” and issued on Mar. 27, 2001; and co-pending U.S. patent application Ser. No. 10/622,520 entitled “Ergonomic Multi-Functional Cleaning Machine” and filed on Jul. 18, 2003.

Non-limiting examples of suitable flexible elastic stretch hose include Product Nos. HP6173 and HP6227 available from the Flexaust company of Chicago Ill. and El Paso Tex.

What is claimed is:

1. A cleaning machine, comprising:
a fresh liquid tank;
a waste recovery tank;
a vacuum motor assembly, the vacuum motor assembly enabling a soil-containing fluid to be vacuumed into the waste recovery tank;
a fresh liquid pump, the fresh liquid pump enabling a liquid or solution to be pumped from the fresh liquid tank;
a blower motor assembly including a working-air outlet; and
a flexible elastic stretch-hose assembly including a length of flexible elastic stretch hose, the length being fluidly connected to the working-air outlet of the blower motor assembly and having an elongation stretch ratio of at least about 2:1.

2. The cleaning machine of claim 1 wherein the length has an elongation stretch ratio of at least about 4.5:1.

3. The cleaning machine of claim 1 wherein the stretch-hose assembly includes a constriction along its length.

4. The cleaning machine of claim 3 wherein the stretch-hose assembly includes a blow nozzle, at least a portion of the constriction being formed by the blow nozzle.

5. The cleaning machine of claim 1 further including a blow nozzle, the blow nozzle being fluidly connectable at an end of the stretch-hose assembly.

6. A cleaning machine, comprising:
a waste recovery tank;
a vacuum motor assembly including a working-air outlet, the vacuum motor assembly enabling a soil-containing fluid to be vacuumed into the waste recovery tank; and
a flexible elastic stretch-hose assembly including a length of flexible elastic stretch hose, the length being fluidly connected to the working-air outlet of the vacuum motor assembly and having an elongation stretch ratio of at least about 2:1.

7. The cleaning machine of claim 6 wherein the length has an elongation stretch ratio of at least about 4.5:1.

8. The cleaning machine of claim 6 wherein the stretch-hose assembly includes a constriction along its length.

9. The cleaning machine of claim 8 wherein the stretch-hose assembly includes a blow nozzle, at least a portion of the constriction being formed by the blow nozzle.

10. The cleaning machine of claim 6 further including a blow nozzle, the blow nozzle being fluidly connectable at an end of the stretch-hose assembly.

11. A cleaning machine, comprising:
a fresh liquid tank;
a waste recovery tank;
a vacuum motor assembly, the vacuum motor assembly enabling a soil-containing fluid to be vacuumed into the waste recovery tank;
a fresh liquid pump, the fresh liquid pump enabling a liquid or solution to be pumped from the fresh liquid tank;
a blower motor assembly including a working-air outlet; and
a flexible elastic stretch-hose assembly including a length of flexible elastic stretch hose, the length being fluidly connectable to the working-air outlet of the blower motor assembly and having an elongation stretch ratio of at least about 2:1.

12. A cleaning machine, comprising:
a waste recovery tank;
a vacuun motor assembly including a working-air outlet, the vacuum motor assembly enabling a soil-containing fluid to be vacuumed into the waste recovery tank; and
a flexible elastic stretch-hose assembly including a length of flexible elastic stretch hose, the length being fluidly connectable to the working-air outlet of the vacuum motor assembly and having an elongation stretch ratio of at least about 2:1.

13. A method of operating a cleaning machine, comprising the step of:
activating a blower motor assembly of a cleaning machine, the blower motor assembly including a working-air outlet,
the cleaning machine further including:
a fresh liquid tank;
a waste recovery tank;
a vacuum motor assembly, the vacuum motor assembly enabling a soil-containing fluid to be vacuumed into the waste recovery tank;
a fresh liquid pump, the fresh liquid pump enabling a liquid or solution to be pumped from the fresh liquid tank; and
a flexible elastic stretch-hose assembly including a length of flexible elastic stretch hose having an elongation stretch ratio of at least about 2:1, the stretch-hose assembly further including a constriction along its length and being fluidly connected to the working-air outlet of the blower motor assembly, whereby the length of flexible elastic stretch hose elongates without an operator having to pull the stretch-hose assembly.

14. The method of claim 13 wherein the length has an elongation stretch ratio of at least about 4.5:1.

15. The method of claim 13 wherein the stretch-hose assembly includes a blow nozzle, at least a portion of the constriction being formed by the blow nozzle.

16. The method of claim 13 farther including a blow nozzle, the blow nozzle being fluidly connectable at an end of the stretch-hose assembly.

17. A method of operating a cleaning machine, comprising the step of:
activating a vacuum motor assembly of a cleaning machine, the vacuum motor assembly including a working-air outlet and enabling a soil-containing fluid to be vacuumed into a waste recovery tank,
the cleaning machine further including:
a waste recovery tank; and
a flexible elastic stretch-hose assembly including a length of flexible elastic stretch hose having an elongation stretch ratio of at least about 2:1, the stretch-hose assembly further including a constriction along its length and being fluidly connected to the working-air outlet of the vacuum motor assembly, whereby the length of flexible elastic stretch hose elongates without an operator having to pull the stretch-hose assembly.

18. The method of claim 17 wherein the length has an elongation stretch ratio of at least about 4.5:1.

19. The method of claim 17 wherein the stretch-hose assembly includes a blow nozzle, at least a portion of the constriction being formed by the blow nozzle.

20. The method of claim 17 further including a blow nozzle, the blow nozzle being fluidly connectable at an end of the stretch-hose assembly.
